(19) United States
(12) Patent Application Publication
(10) Pub. No.: US 2018/0245542 A1
(43) Pub. Date: Aug. 30, 2018

(54) ACOUSTIC COMPRESSION ENGINE

(71) Applicant: Honda Patents & Technologies North America, LLC, Torrance, CA (US)

(72) Inventor: Brett M. Schoppa, Summerfield, NC (US)

(21) Appl. No.: 15/963,681

(22) Filed: Apr. 26, 2018

Related U.S. Application Data
(63) Continuation-in-part of application No. 15/334,783, filed on Oct. 26, 2016.
(60) Provisional application No. 62/246,814, filed on Oct. 27, 2015.

(51) Int. Cl. F02K 7/04; F02K 7/06; F23C 15/00

(52) U.S. Cl. CPC F02K 7/04; F23C 15/00; F02K 7/06

(57) ABSTRACT

An acoustic compression engine that includes an air intake section adapted to intake a volume of air. The volume of air is mixed with fuel within the air intake section. The acoustic compression engine also includes a resonant chamber adapted to intake a volume of air mixed with fuel from the air intake section. Compression of the volume of air mixed with fuel occurs within the resonant chamber and compression of the volume of air and fuel mixture is based on combustion of compressed air and fuel mixture and a resonant cycle of the acoustic compression engine. The acoustic compression engine further includes at least one exhaust nozzle that controls an exit of exhaust of gas that includes the combustion products at a requisite pressure to yield a thrust.

### CROSS-REFERENCE TO RELATED APPLICATION

This application is a continuation-in-part of, and claims priority to, U.S. application Ser. No. 15/334,783, filed on Oct. 26, 2016, which is incorporated herein by reference, and which claims priority to U.S. Provisional Application Ser. No. 62/246,814, filed on Oct. 27, 2015.

### BACKGROUND

The subject matter disclosed herein relates to acoustic compression, and more specifically, to the utilization of acoustic compression within a jet engine.

Conventional jet engines such as a turbo jet engine or a turbo fan engine use several stages to compress incoming air within a compressor before releasing compressed air. Additionally, such jet engines utilize several turbine stages for recovering energy from combustion products to drive the compressor to compress the incoming air. Such complexity has been necessary to achieve the large pressure ratios, power to weight ratios and specific fuel consumption seen in conventional engines. However, such results have been achieved at a high monetary cost and by utilization of complex mechanisms.

Typically, simpler jet engines are currently less utilized since they offer poor fuel efficiency and a low overall performance. In particular, the poor fuel efficiency and low overall performance is due mainly to an inadequate amount of compression of fuel air mixture by the engine before the mixture is fed to the combustion chamber.

### SUMMARY

In one aspect, an acoustic compression engine that includes an air intake section adapted to intake a volume of air. The volume of air is mixed with fuel within the air intake section. The acoustic compression engine also includes a resonant chamber adapted to intake a volume of air mixed with fuel from the air intake section. Compression of the volume of air mixed with fuel occurs within the resonant chamber and compression of the volume of air and fuel mixture is based on combustion of compressed air and fuel mixture and a resonant cycle of the acoustic compression engine. The acoustic compression engine further includes at least one exhaust nozzle that controls an exit of exhaust of gas that includes the combustion products at a requisite pressure to yield a thrust.

In another aspect, a method of operation for an acoustic compression engine that includes receiving a volume of air. The volume of air is mixed with fuel within an air intake section of the acoustic compression engine. The method also includes controlling entry of a volume of air and fuel mixture into a resonant chamber of the acoustic compression engine. The method additionally includes compressing the volume of air and fuel mixture within the resonant chamber. The method further includes burning a volume of compressed air and fuel mixture within the resonant chamber and producing combustion products. Compressing the volume of air and fuel mixture is based on burning the volume of compressed air and fuel mixture and a resonant cycle of the acoustic compression engine.

In yet another aspect, an acoustic compression engine that includes a resonant chamber adapted to receive a volume of ambient air. The acoustic compression engine additionally includes a burner can included within the resonant chamber that mixes fuel with the volume of ambient air and burns at least a portion of a volume of compressed air and fuel mixture to produce combustion products. Pressure oscillations are generated within the resonant chamber to compress the volume of ambient air during operation of the acoustic compression engine. The acoustic compression engine further includes at least one active variable exhaust nozzle included at an aft end of the resonant chamber that controls an exit of exhaust gas that includes the combustion products at a requisite pressure to maintain the pressure oscillations within the resonant chamber.

### BRIEF DESCRIPTION OF THE DRAWINGS

FIG. 1 is a schematic diagram of an acoustic compression engine according to an exemplary embodiment;

FIG. 2 is a schematic diagram of an alternate embodiment of the acoustic compression engine including a burner can within a resonant chamber;

FIG. 3 illustrates an exploded view of a single tapered shaped configuration of the resonant chamber of the acoustic compression engine during an expansion and intake phase of a resonant cycle according to an exemplary embodiment;

FIG. 4 illustrates an exploded view of the single tapered shaped configuration of the resonant chamber of the acoustic engine during a compression phase of the resonant cycle according to an exemplary embodiment;

FIG. 5 illustrates an exploded view of the single tapered shaped configuration of the resonant chamber of the acoustic engine during another expansion and intake phase of the resonant cycle according to an exemplary embodiment;

FIG. 6A illustrates an exploded view of the double tapered shaped configuration of the resonant chamber of the acoustic engine during the expansion and intake phase of the resonant cycle according to an exemplary embodiment;

FIG. 6B illustrates an exploded view of the double tapered shaped configuration of the resonant chamber of the acoustic engine during the compression phase of the resonant cycle according to an exemplary embodiment; and

FIG. 7 illustrates an exemplary method of operation of the acoustic compression engine according to an exemplary embodiment.

### DETAILED DESCRIPTION

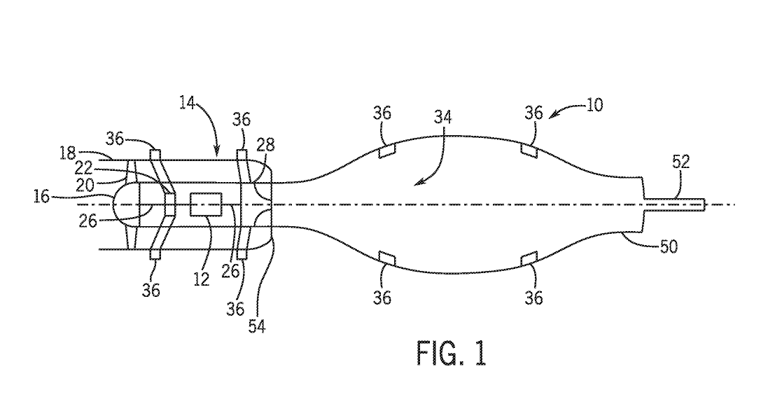

FIG. 1 shows a schematic diagram of an acoustic compression engine 10 (herein referred to as “acoustic engine”) according to an exemplary embodiment. In this embodiment, the acoustic engine 10 includes an air intake section 14 that is disposed towards a forward end 18 of the acoustic engine 10. The acoustic engine 10 also includes a resonant chamber 34 in which combustion and acoustic compression takes place within the acoustic engine 10. As will be described below, the resonant chamber 34 may be shaped in different manners, including, but not limited to, a single tapered configuration and a double tapered configuration. In one embodiment, the acoustic engine 10 may include an electronic control unit (not shown) that may be configured to receive user input and/or send programmed commands that provide control over components of the acoustic engine 10. For example, the electronic control unit may permit user control and adjustment of operational variables pertaining to the acoustic engine 10.

The acoustic engine 10 may include one or more bleed ports 36 that may be disposed on side of the air intake section 14 and/or the resonant chamber 34 to intake and/or channel air to specific components/regions of the acoustic engine 10. In one embodiment, air from the one or more bleed ports 36 may include bleed air (e.g., compressed air) provided from the resonant chamber 34 and fed to the other bleed port(s) 36 within the air intake section 14 of the acoustic engine 10. In other words, air that is compressed within the resonant chamber 34 (compression is discussed in more detail below) may be provided to specific components/regions of the acoustic engine 10. In some embodiments, the bleed ports 36 may include high pressure bleed ports (not shown) and low pressure bleed ports (not shown) that can be located at different locations to accommodate various levels of air pressure within the resonant chamber 34 during resonance cycles.

In an exemplary embodiment, the air intake section 14 of the acoustic engine 10 includes a starter/generator 12 that is in operational communication with components of the acoustic engine 10. In one embodiment, the starter/generator 12 may be operably connected to a battery (not shown) that may supply a predetermined amount of power required to operate (e.g., enable) the starter/generator 12 to facilitate startup of the acoustic engine 10. After the startup of the acoustic engine 10, the starter/generator 12 is operated by a turbine 22 that may function based on bleed air that is provided through the bleed ports 36. In other words, after the initial startup of the acoustic engine 10 based on power provided by the battery to operate the starter/generator 12, a specific volume of bleed air provided from the resonant chamber 34 and fed to other bleed port(s) 36 within the air intake section 14 may be utilized to operate the turbine 22. In one embodiment, the turbine 22 includes a shaft 26 that is operably connected to one or more components of the acoustic engine 10. The shaft 26 may be initially rotated based on the power supplied to the starter/generator 12 by the battery 24. The shaft 26 may be subsequently rotated during the duration of operation of the acoustic engine 10 based on bleed air that is provided through the bleed ports 36 to operate the turbine 22.

In one or more embodiments, the acoustic engine 10 may include an inlet impeller fan 16 that is housed within the air intake section 14 and positioned at the forward end 18 of the acoustic engine 10. The inlet impeller fan 16 includes a plurality of blades 20 that are configured to rotate and intake a volume of air through the inlet impeller fan 16. The inlet impeller fan 16 may be configured to provide an initial starting airflow that is fed through the acoustic engine 10.

In one embodiment, the shaft 26 of the turbine 22 may be operably connected to the inlet impeller fan 16. Initially, during the initial startup of the acoustic engine 10 upon the battery 24 supplying power to operate starter/generator 12, the starter/generator 12 may incidentally operate the turbine 22 to rotate the shaft 26 and consequently rotate the plurality of blades 20 of the inlet impeller fan 16. However, after the initial startup when bleed air is provided to operate the turbine 22, the plurality of blades 20 of the inlet impeller fan 16 may rotate to intake a volume of air based solely on the bleed air. In other words, the starter/generator 12 may cease to operate the turbine 22 and the inlet impeller fan 16 after the initial startup of the acoustic engine 10.

In an exemplary embodiment, the turbine 22 may also be operably connected to an active valve that may be in a form of a rotary valve 28 through the shaft 26. For example, the rotary valve 28 may be operably coupled between the air intake section 14 and the resonant chamber 34. In particular, in some embodiments, the rotary valve 28 may be disposed at an aft end 54 of the air intake section 14. As described in more detail below, the rotary valve 28 may be configured to control entry of the volume of air into the resonant chamber 34 based on an opening of the rotary valve 28. In one embodiment, the rotary valve 28 may operate in lieu of the inlet impeller fan 16. More specifically, the rotary valve 28 may be configured to act as an impeller that draws a volume of air into the resonant chamber 34 as the rotary valve 28 is being rotated.

In one or more embodiments, the rotary valve 28 may be rotated to maintain pressure and provide a seal between the air intake section 14 and the resonant chamber 34. As described below, the rotary valve 28 may rotate to open and close in synchronization with operational cycles of the acoustic engine 10. In some embodiments, the speed of the rotation of the rotary valve 28 may be regulated by the starter/generator 12. In alternate embodiments, the speed of rotation of the rotary valve 28 may be regulated by a separate motor and speed controller (not shown) that may be operably connected to the rotary valve 28.

In one embodiment, upon the initial startup of the acoustic engine 10, bleed air may be utilized to operate the shaft 26 of the turbine 22 and consequently rotate the rotary valve 28 at a frequency to be in an open position or semi-open position from a closed position to allow all or some of air to be drawn into the resonant chamber 34. Similarly, the shaft 26 of the turbine 22 may separately rotate the rotary valve 28 at a frequency to be in the closed position or semi-closed position from the open position to disallow all or some of the air to be drawn into the resonant chamber 34 and seal the resonant chamber 34 in a closed position in order to pressurize the air within the resonant chamber 34. In some embodiments, the turbine 22 may regulate the rotation of the rotary valve 28 such that the rotary valve 28 may be opened and closed to be in synchronization with the operational frequency of the resonant chamber 34 to produce oscillations. In an alternate embodiment, the rotation of the rotary valve 28 may be partially or fully accomplished through bleed air provided by the bleed ports 36 such that the shaft 26 may not be used or may only be partially used to operate the rotary valve 28.

In an additional embodiment, the active valve may be in a form of a poppet valve(s) (not shown) that may be connected to the shaft 26 and may functionally operate in a similar manner of the rotary valve 28 to maintain pressure and provide a seal between the air intake section 14 and the resonant chamber 34 of the acoustic engine 10. The poppet valve(s) may include a rounded or oval opening and a valve stem (not shown) that may be used to plug the opening and seal the airflow between the air intake section 14 and the resonant chamber 34. In an additional embodiment, the active valve may be in a form of a passive valve(s) (not shown) and may functionally operate in a similar manner of the rotary valve 28 to maintain pressure and provide a seal between the air intake section 14 and the resonant chamber 34 of the acoustic engine 10. It is to be appreciated that the general functionality of the poppet valve(s) and/or the passive valve(s) will accomplish similar results to the functionality of the rotary valve 28, shown in the embodiment of FIG. 1, and described in more detail below.

The rotary valve 28 may include a body that is configured of one or more openings (not shown) that are capable of being rotated to be in an opened or closed position to maintain pressure and provide a seal between the air intake section 14 and the resonant chamber 34. In one embodiment, the rotary valve 28 may be opened when the pressure level of the forward end of the resonant chamber 34 is below a threshold pressure level. The threshold pressure level may be a pressure that is equal to atmospheric pressure to allow the volume of air to enter the resonant chamber 34. It is contemplated that based on the configuration of the rotary valve 28, the pressure force within the resonant chamber 34 may be aligned with the rotary axis of the rotary valve 28 thereby lowering the wear of the components of the rotary valve 28. In some embodiments, the rotary valve 28 may be mounted to a thrust bearing (not shown) that may react the pressure loads exerted upon the rotary valve 28 during the resonance cycles that occur within the resonant chamber 34.

As explained in more detail below, the rotary valve 28 may be rotated to be in the opened or closed position based on the timing of the resonance cycle occurring within the resonant chamber 34. In one embodiment, the rotary valve 28 may be rotated to be in the opened position when a threshold pressurization (e.g., sub-atmospheric) is reached at a frond end of the resonant chamber 34. Additionally, the rotary valve 28 may be actively rotated to be in the closed position when the threshold pressurization is reached (e.g., above atmospheric) at the front end of the resonant chamber 34. Therefore, during a resonant cycle when the pressure at the front end of the resonant chamber 34 is below the threshold pressurization, the rotary valve 28 may be rotated to the opened position to allow air to be fed to the resonant chamber 34 from the air intake section 14 for compression and combustion.

In an alternate embodiment, the rotary valve 28 may be rotated to be in the opened or closed position based on a predetermined volume of air being inlet to the resonant chamber 34 from the air intake section 14 within a predetermined amount of time. In particular, the rotary valve 28 may be rotated to be in the opened position until a predetermined volume of air is passed through the rotary valve 28 into the resonant chamber 34. Thereinafter, the rotary valve 28 may be rotated to be in the closed position for the predetermined amount of time (e.g., an amount of time at which the resonant cycle takes place within the resonant chamber 34) and then rotated to be in the opened position.

In an additional embodiment, the electronic control unit may be configured to receive user input and/or have preprogrammed commands that provide for automatic and/or manual control of the rotary valve 28. In particular, the electronic control unit 38 may permit user control and adjustment of operational variables, including, without limitations, a timing sequence for the rotation of the rotary valve 28 to be in the opened position or the closed position, monitoring and receiving user input on various temperature and pressure level settings of components of the acoustic engine 10, and setting a level of the opening or closing position of the rotary valve 28.

With continued reference to FIG. 1, the length of the resonant chamber 34 may have an impact on the operational frequency of the acoustic engine 10 such that a high or lower frequency of cycles may take place based on the shorter or longer length of the chamber 34. In another embodiment, the shape of the resonant chamber 34 may have an impact on the power and thrust produced by the engine as well as the fuel efficiency of the acoustic engine 10. For example, a smaller tapered end of the resonant chamber 34 may produce higher pressures and greater fuel economy. Therefore, a change in a cross sectional area of the chamber 34 along its length (e.g., the manner in which the resonant chamber 34 is tapered) may have a significant effect on the performance of the acoustic engine 10.

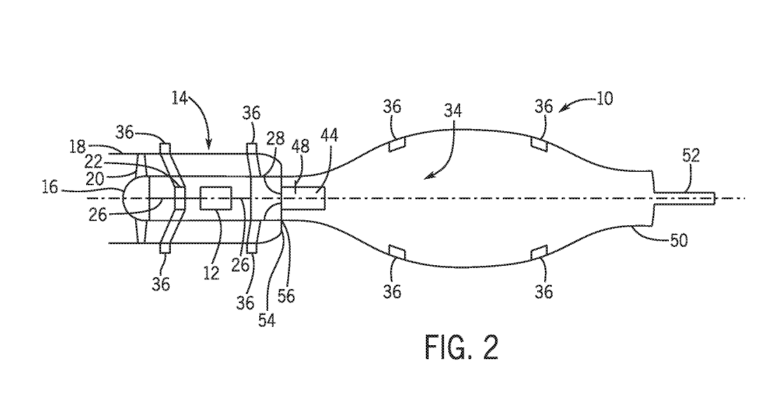

With reference to FIG. 2, an alternate embodiment of the acoustic engine 10 that includes a burner can/combustor 44 (herein referred to as “burner can”) is shown, according to an exemplary embodiment. As shown, the burner can 44 may be disposed within the resonant chamber 34 and may be configured to accept a flow of air/fuel mixture that is to be ignited within the burner can 44. It is contemplated that the physical configuration of the burner can 44 may provide high fuel efficiency and low exhaust gas temperature since combustion products may be mixed with the rest of the compressed air after the combustion process starts based on the length of the burner can 44.

In one embodiment, the burner can 44 may include one or more fuel injectors (not shown) that may be configured as a fuel spray bar (not shown) and may provide fuel that may be mixed with the air inlet into the resonant chamber 34 through the rotary valve 28. Within this embodiment, the burner can 44 may be configured at a length that is preferably long enough that a significant mixing of air and fuel occurs. As air and fuel are mixed and flow through the burner can 44, one or more spark plugs 48 that may be included within the burner can 44 may be utilized to ignite a mixture of the air and fuel that has been compressed, as described in more detail below.

With reference to FIGS. 1 and 2, in an exemplary embodiment, the resonant chamber 34 includes one or more exhaust nozzles 52 that are disposed at the aft end of the resonant chamber 34. The one or more exhaust nozzles 52 may be configured to provide for a variable exhaust area of the acoustic engine 10 that may be controlled to provide a necessary backpressure for the operation of the acoustic engine 10. In particular, the opening of one or more exhaust nozzles 52 may be variable for causing the flow velocity of an exhaust gas to be regulated based on a desired power/thrust.

The one or more exhaust nozzles 52 may be specifically sized to allow highly pressurized fluid within the resonant chamber 34 to be released at a moderated pressure to produce thrust. As explained in more detail below, the one or more exhaust nozzles 52 may be configured with an exit area that is preferably small enough to provide a requisite amount of back pressure within the resonant chamber 34 to maintain the pressure oscillations within the resonant chamber 34.

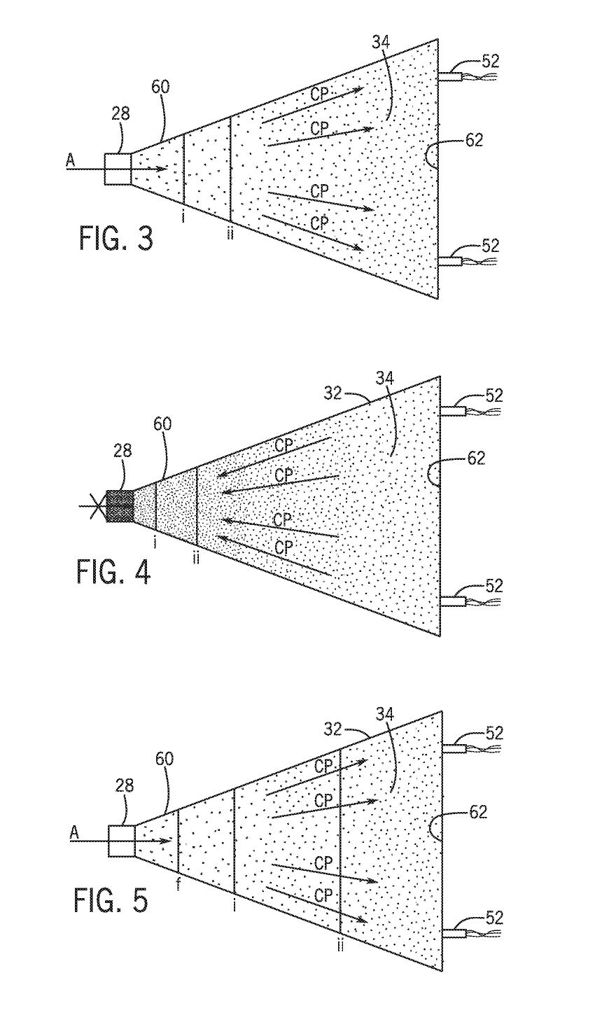

FIG. 3 illustrates an exploded view of a single tapered shape configuration of the resonant chamber 34 of the acoustic compression engine 10 during the expansion and intake phase of a resonant cycle according to an exemplary embodiment. In one embodiment, during the expansion and intake phase of the resonant cycle, the rotary valve 28 of the acoustic engine 10 may be rotated to be opened when the chamber pressure is below ambient.

In an exemplary embodiment, as described below, the rotary valve 28 is opened when the pressure at a tapered end 60 (front end) of the resonant chamber 34 is less than atmospheric pressure. In other words, as the pressure level of the tapered end 60 (front end) of the resonant chamber 34 is below a threshold pressure level (e.g., sub-atmospheric pressure), a volume of air or air/fuel mixture depicted in FIG. 3 by the arrow labeled ‘A’ may be allowed to enter the resonant chamber 34. More specifically, in one embodiment, upon the rotary valve 28 being opened, a volume of air/fuel mixture that is mixed outside of the resonant chamber 34 (e.g., by a fuel injection spray (not shown) disposed within the air intake section 14) and is supplied to the resonant chamber 34. The timing of the injection of fuel may be controlled such that air flow may enter the resonant chamber 34 before the air/fuel mixture enters the resonant chamber 34 prior to the closure of the rotary valve 28. In another embodiment, the rotary valve 28 of the acoustic engine 10 may be opened to allow a volume of air to enter the resonant chamber 34 to be mixed with fuel based on fuel supplied within the resonant chamber 34 (e.g., by a fuel injection spray (not shown)) disposed within the resonant chamber 34). The timing of the injection of fuel that is to be mixed with the inflow of air may be controlled by the electronic control unit to be injected during a specific part of the intake phase.

In one embodiment, at the point in time at which the rotary valve 28 is opened to allow the volume of air or air/fuel mixture to enter, the resonant chamber 34 is also filled with combustion products from previous operating cycles of the acoustic engine 10 (combustion described in more detail below). Based on combustion that occurs during previous operating cycles, previous combustion products depicted around/after the portion ‘ii’ (e.g., a previous combustion cycle boundary) within FIG. 3 will flow toward an aft end 62 of the resonant chamber 34. During the intake phase, these combustion products may expand and decrease pressure while flowing toward the aft end 62 of the resonant chamber 34, as depicted by the arrows labeled ‘CP’ that describe the motion of the previous combustion products. Consequently, the pressure at the aft end 62 of the resonant chamber 34 will slightly increase at its peak and reach above the average pressure at the aft end 62 within this single-tapered configuration of the resonant chamber 34.

During the intake phase, the exhaust of gas that includes combustion products will flow through the one or more exhaust nozzles 52 to yield a thrust. As discussed, the one or more exhaust nozzles 52 may be variably controlled to release a volume of exhaust gas that is requisite to yield the thrust. Additionally, during the intake phase, a low pressure (partial vacuum) is created at the tapered end 60 of the resonant chamber 34 as the volume of air or air/fuel mixture enters the resonant chamber 34. As described below, pressure at the tapered end 60 of the resonant chamber 34 consequently increases and the volume of air or air/fuel mixture ceases as it reaches a portion of the resonant chamber 34 depicted by line ‘i’ (e.g., a fresh air boundary).

FIG. 4 illustrates an exploded view of the single tapered shaped configuration of the resonant chamber 34 of the acoustic engine 10 during the compression phase of the resonant cycle. In an exemplary embodiment, when the inflow of air/fuel mixture that is passed through the rotary valve 28 ceases at ‘i’, as pressure builds at the tapered end 60 of the resonant chamber 34 above an ambient pressure, the rotary valve 28 is closed thereby disallowing intake of volume of air or air/fuel mixture. More specifically, during the compression phase, the previous combustion products will flow toward the (closed) tapered end 60 of the resonant chamber 34, as depicted by the arrows labeled ‘CP’ in FIG. 4. Consequently, the pressure and density at the tapered end 60 of the resonant chamber 34 will increase as the flow of combustion products continues towards the (closed) tapered end 60.

In an exemplary embodiment, based on the momentum of the previous combustion products that results from the reverse flow of previous combustion products toward the tapered end 60 of the resonant chamber 34 (depicted by the arrows labeled as ‘CP’), the air/fuel mixture (either mixed outside of the resonant chamber 34 or within the resonant chamber 34, as discussed above) is compressed during this phase based on pressure oscillations that occur within the resonant chamber 34. During the compression phase, the exhaust of gas that includes combustion products will continue to flow through the one or more exhaust nozzles 52 to continue to yield the thrust.

In an exemplary embodiment, upon compression of the air/fuel mixture combustion of the mixture will take place. In one embodiment, the compressed mixture may be automatically ignited due to the rise of temperature and pressure within the resonant chamber 34 that is achieved due to the resonant cycle. Within this embodiment, the timing of the injection of fuel may be controlled such that air flow may enter without fuel before the air/fuel mixture enters the resonant chamber 34 just prior to the closure of the rotary valve 28. It is contemplated that such timing of the injection of fuel will increase fuel efficiency and decrease the operating temperature of the acoustic engine 10.

In an alternate embodiment, with reference to FIG. 2 and FIG. 4, the one or more spark plugs 48 of the burner can 44 may be utilized to ignite the air/fuel mixture that has been compressed. Within this embodiment, the timing of the injection of fuel may be controlled such that air flow may enter without fuel before the air/fuel mixture enters the resonant chamber 34 just prior to the closure of the rotary valve 28. As combustion takes place, the pressure and temperature at the tapered end 60 of the resonant chamber 34 will consequently continue to increase well above the ambient pressure due to combustion. As will be appreciated, this continued rise in pressure and temperature at the tapered end 60 of the resonant chamber 34 after closure of the rotary valve 28 due to combustion will provide a requisite amount of energy to continue the resonant cycle.

FIG. 5 illustrates an exploded view of the single tapered shaped configuration of the resonant chamber 34 of the acoustic engine 10 during another expansion and intake phase of the resonant cycle according to an exemplary embodiment. As discussed, the combustion of the air/fuel mixture raises the temperature and pressure at the tapered end 60 of the resonant chamber. As this occurs, new combustion products produced during the combustion of the air/fuel mixture expand and thereby force the flow of previous combustion products toward the aft end 62 of the resonant chamber. More specifically, during the expansion and intake phase, the previous combustion products depicted around/after the portion ‘i’ (e.g., the previous combustion cycle boundary) within FIG. 5 will flow toward the aft end 62 of the resonant chamber 34, as depicted by the arrows labeled ‘CP’ in FIG. 5.

The combustion products may expand and decrease pressure while flowing toward the aft end 62 of the resonant chamber 34, as depicted by the arrows labeled ‘CP’ that describe the motion of the previous combustion products. Consequently, the pressure and density at the aft end 62 of the resonant chamber 34 will again increase as the flow of combustion products continues towards the aft end. Also, the pressure at the tapered end 60 of the resonant chamber 34 will decrease below ambient pressure. Upon decrease of the pressure at the tapered end 60 below ambient pressure, the rotary valve 28 will once again be opened. When the rotary valve 28 is opened the air or air/fuel mixture will enter the resonant chamber 34 during the expansion and intake phase (new fresh air boundary at ‘f’) and the pressure at the aft end 62 will again increase slightly at its peak. In other words, the acoustic engine 10 will continue to operate, repeating the resonant cycle, as described above with respect to FIG. 3.

Based on the aforementioned resonant cycle (that will occur numerous times based on the duration of operation of the acoustic engine 10), the tapered end 60 of the resonant chamber 34 will experience a large pressure swing from high to low and low to high while the aft end 62 of the resonant chamber 34 will oscillate only slightly and opposite to the pressure at the tapered end 60. It is contemplated that the single tapered design of the resonant chamber 34, as shown in FIGS. 3, 4, and 5, will yield a more uniform thrust as the pressure at the larger aft end of the resonant chamber 34 will be above atmospheric and only fluctuate slightly, yielding a near constant thrust from the one or more exhaust nozzles 52.

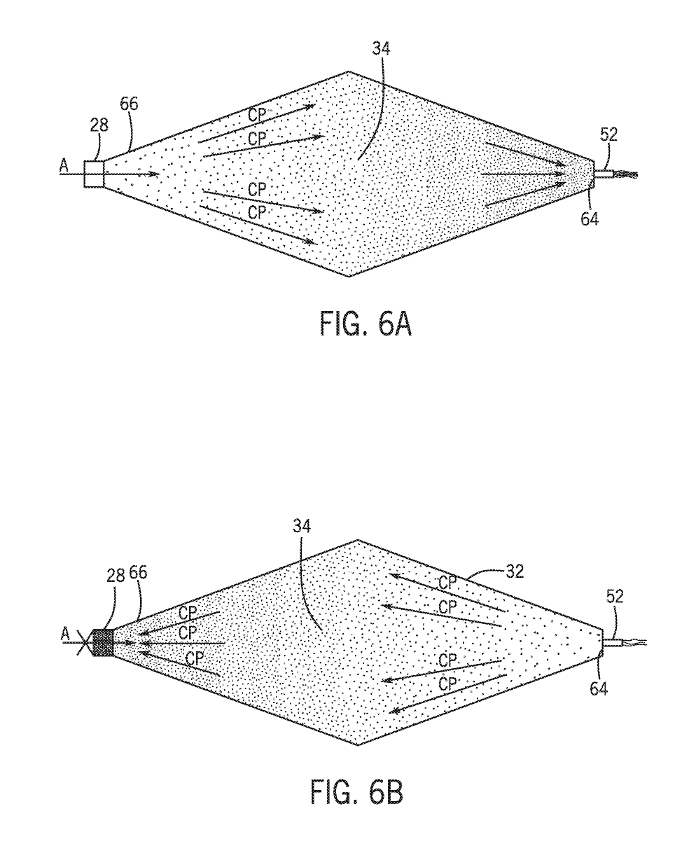

FIG. 6A illustrates an exploded view of the double tapered shaped configuration of the resonant chamber 34 of the acoustic engine 10 during the expansion and intake phase of the resonant cycle according to an exemplary embodiment. As shown, the double tapered configuration includes a tapered front end 66 in which air or air/fuel mixture may enter through the rotary valve 28 and a tapered aft end 64 which includes the one or more exhaust nozzles 52. FIG. 6B illustrates an exploded view of the double tapered shaped configuration of the resonant chamber 34 of the acoustic engine 10 during the compression phase of the resonant cycle according to an exemplary embodiment. It is contemplated that the double tapered shaped configuration of the resonant chamber 34, as shown in FIGS. 6A and 6B, allows the resonant cycle to occur in a similar manner as the single tapered shaped configuration, discussed above. However the resonant chamber 34 with the double tapered configuration is configured as being of a lighter weight than the single tapered shaped configuration.

During the resonant cycle, the pressure will be higher at the one or more exhaust nozzles 52 located at the tapered aft end 64 of the resonant chamber 34 of the double tapered configuration as oppose to the exhaust nozzles 52 located at the non-tapered aft end 60 of the single tapered configuration. Therefore, the pressure will fluctuate with respect to the double tapered configuration to a greater degree than the single tapered configuration of the resonant chamber 34. In other words, the thrust may not be as uniform and constant as with the single tapered shaped configuration of the resonant chamber 34.

In an alternate embodiment, with reference to FIG. 6A and FIG. 6B, inlets (not shown) may be utilized at both the forward end 66 and aft end 64 of the double tapered chamber. One or more exhaust nozzles 52 will then be provided midway between the forward 66 and aft 64 ends of the acoustic engine 10. This configuration has the advantage of having twice as many power pulses per resonant cycle while yielding a more continuous thrust level.

It is contemplated that with both the single tapered and double tapered shaped configurations of the resonant chamber 34, several resonance cycles may be required for the combustion products to travel the length of the resonant chamber 34 and exit the acoustic engine 10 through the one or more exhaust nozzles 52. The expansion of the combustion products provide the driving force to continue the resonant cycles during operation of the acoustic engine 10. Based on these configurations of the resonant chamber 34, the acoustic engine 10 may run within a relatively narrow frequency range.

It is also contemplated that both the single tapered and double tapered shaped configurations of the resonant chamber 34 may be configured such that the combustion products within the chamber 34 will resonate at a desired operational frequency. Additionally, both configurations of the resonant chamber 34 may be configured so that oscillation occurring within the resonant chamber 34 occurs at sub-sonic values such that shock waves do not form within the resonant chamber 34.

Additionally, it is contemplated that in some configurations, the acoustic engine 10 may also be utilized as part of an electrical generation system. In particular, the acoustic engine 10 may cause a turbine (not shown) to rotate. The turbine may be attached to a generator (not shown) of the electrical generation system that may be rotated to generate electricity based on the rotation of the turbine.

It is to be appreciated that in one or more embodiments, the single tapered or double tapered configurations of the resonant chamber 34 may be provided in different variations with respect to shape. For example, the tapered aft end 64 of the double-tapered configuration of the resonant chamber 34 may be provided with a smaller or larger taper than the tapered front end 66 of the resonant chamber 34. Additionally, it is to be appreciated that additional shapes may be contemplated with respect to the configuration of the resonant chamber 34 of the acoustic engine 10.

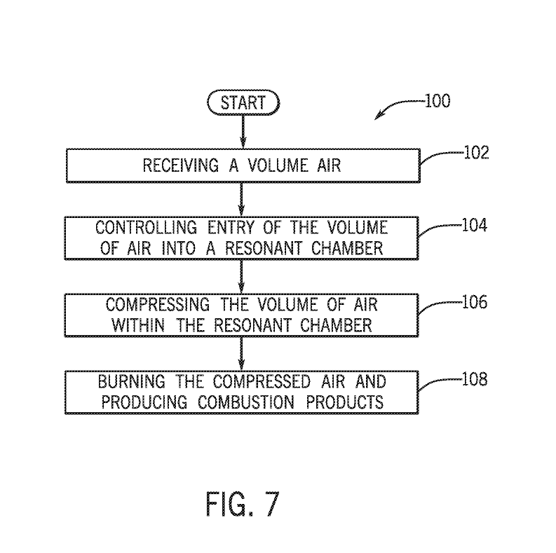

It is contemplated that the acoustic engine 10 described herein may be operated according to various methods. Merely by way of example, referring to FIG. 7, one method 100 for the acoustic engine 10 includes receiving a volume of air, at block 102. At block 104, the method may include controlling entry of the volume of air into a resonant chamber. At block 106, the method may include compressing the volume of air within the resonant chamber. At block 108, the method may include burning the compressed air and producing combustion products.

The foregoing description of embodiments and examples has been presented for purposes of illustration and description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. The scope is, of course, not limited to the examples or embodiments set forth herein, but can be employed in any number of applications and equivalent devices by those of ordinary skill in the art. Rather, it is hereby intended the scope be defined by the claims appended hereto. Additionally, the features of various implementing embodiments may be combined to form further embodiments.

1. An acoustic compression engine, comprising:
an air intake section adapted to intake a volume of air, wherein the volume of air is mixed with fuel within the air intake section;
a resonant chamber adapted to intake the volume of air mixed with fuel from the air intake section, wherein compression of the volume of air mixed with fuel occurs within the resonant chamber, wherein compression of the volume of air and fuel mixture is based on combustion of compressed air and fuel mixture and a resonant cycle of the acoustic compression engine; and
at least one exhaust nozzle that controls an exit of exhaust of gas that includes combustion products at a requisite pressure to yield a thrust.

2. The acoustic compression engine of claim 1, wherein the resonant chamber is configured as at least one of: a single tapered shaped resonant chamber that includes a front end that is configured as a tapered end and an aft end that is configured as a wider end than the tapered end that includes the at least one exhaust nozzle, and a double tapered shaped resonant chamber that includes the front end that is configured as a tapered front end and a tapered aft end that is configured as a second tapered end that includes the at least one exhaust nozzle.

3. The acoustic compression engine of claim 1, wherein an active valve is configured to control entry of the volume of air and fuel mixture into the resonant chamber based on an opening of the active valve, wherein the active valve is configured to be in an opened position or a closed position, wherein the active valve is configured to be in the opened position during an expansion and intake phase of the resonant cycle, wherein a pressure at a front end of the resonant chamber is below atmospheric pressure and the volume of air and fuel mixture enters the resonant chamber.

4. The acoustic compression engine of claim 3, wherein the resonant chamber is filled with the combustion products based on the combustion that occurs during previous operating cycles of the acoustic compression engine, wherein previous combustion products flow toward an aft end of the resonant chamber during the expansion and intake phase of the resonant cycle.

5. The acoustic compression engine of claim 4, wherein the previous combustion products reverse the flow from the aft end of the resonant chamber to the front end of the resonant chamber and the pressure at the front end of the resonant chamber increases above atmospheric pressure, wherein a compression phase of the resonant cycle begins and the active valve is configured to be in the closed position.

6. The acoustic compression engine of claim 5, wherein the acoustic compression engine is configured to have an operational frequency that generates pressure oscillations within the resonant chamber to compress the volume of air and fuel mixture during operation of the acoustic compression engine, wherein a momentum of the previous combustion products that results from a reverse flow of previous combustion products causes the volume of air and fuel mixture to be compressed based on the pressure oscillations within the resonant chamber during the compression phase of the resonant cycle.

7. The acoustic compression engine of claim 6, wherein combustion of the air and fuel mixture occurs during the compression phase of the resonant cycle, wherein the compressed air and fuel mixture is automatically ignited based on a rise of temperature and pressure within the resonant chamber that occurs during the resonant cycle.

8. The acoustic compression engine of claim 7, wherein combustion of the air and fuel mixture raises the temperature and pressure at the front end of the resonant chamber, wherein new combustion products produced during the combustion of the air and fuel mixture expand and reverse the flow of the previous combustion products from the front end of the resonant chamber to the aft end of the resonant chamber, wherein a subsequent expansion and intake phase occurs and the active valve is configured to be in the opened position.

9. A method of operation for an acoustic compression engine, the method comprising:
receiving a volume of air, wherein the volume of air is mixed with fuel within an air intake section of the acoustic compression engine;
controlling entry of a volume of air and fuel mixture into a resonant chamber of the acoustic compression engine;
compressing the volume of air and fuel mixture within the resonant chamber; and
burning a volume of compressed air and fuel mixture within the resonant chamber and producing combustion products, wherein compressing the volume of air and fuel mixture is based on burning the volume of compressed air and fuel mixture and a resonant cycle of the acoustic compression engine.

10. The method of claim 9, wherein controlling entry of the volume of air and fuel mixture includes configuring an active valve to control entry of the volume of air and fuel mixture based on an opening of the active valve, wherein the active valve is configured to be in an opened position or a closed position.

11. The method of claim 10, wherein the active valve is configured to be in the opened position during an expansion and intake phase of the resonant cycle, wherein a pressure at a front end of the resonant chamber is below atmospheric pressure and a volume of air and fuel mixture enters the resonant chamber.

12. The method of claim 11, wherein controlling entry of the volume of air and fuel mixture includes filling the resonant chamber with at least one of: fuel from at least one fuel injector and the combustion products based on combustion that occurs during previous operating cycles of the acoustic compression engine, wherein previous combustion products flow toward an aft end of the resonant chamber during the expansion and intake phase of the resonant cycle.

13. The method of claim 12, wherein compressing the volume of air and fuel mixture includes reversing flow of the previous combustion products from the aft end of the resonant chamber to the front end of the resonant chamber and increasing the pressure at the front end of the resonant chamber above atmospheric pressure, a compression phase of the resonant cycle begins and the active valve is configured to be in the closed position.

14. The method of claim 13, wherein compressing the volume of air and fuel mixture includes generating pressure oscillations within the resonant chamber to compress the volume of air and fuel mixture during operation of the acoustic compression engine, wherein a momentum of the previous combustion products that results from a reverse flow of previous combustion products causes the volume of air and fuel mixture to be compressed based on the pressure oscillations within the resonant chamber during the compression phase of the resonant cycle, wherein at least one spark plug is utilized to ignite the volume of air and fuel mixture that has been compressed.

15. The method of claim 14, wherein burning a volume of the compressed air and fuel mixture includes automatically igniting the volume of air and fuel mixture based on a rise of temperature and pressure within the resonant chamber that occurs during the resonant cycle, wherein combustion of the volume of air and fuel mixture is completed during the compression phase of the resonant cycle.

16. The method of claim 15, further including raising the temperature and pressure at the front end of the resonant chamber based on the combustion of the air and fuel mixture, wherein new combustion products produced during the combustion of the air and fuel mixture expand and force a flow of the previous combustion products toward the aft end of the resonant chamber, wherein a subsequent expansion and intake phase occurs and the active valve is configured to be in the opened position.

17. An acoustic compression engine, comprising:
a resonant chamber adapted to receive a volume of ambient air;
a burner can included within the resonant chamber that mixes fuel with the volume of ambient air and burns at least a portion of a volume of compressed air and fuel mixture to produce combustion products, wherein pressure oscillations are generated within the resonant chamber to compress the volume of ambient air during operation of the acoustic compression engine; and
at least one active variable exhaust nozzle included at an aft end of the resonant chamber that controls an exit of exhaust gas that includes the combustion products at a requisite pressure to maintain the pressure oscillations within the resonant chamber.

18. The acoustic compression engine of claim 17, further including a rotary valve that is operatively coupled adjacent to a front end of the resonant chamber, the rotary valve is configured to control entry of the volume of ambient air into the resonant chamber based on a rotation of the rotary valve in an opened position and a closed position, wherein the rotary valve is configured to act as an impeller and draw the volume of ambient air into the resonant chamber as its being rotated in the opened and the closed position.

19. The acoustic compression engine of claim 18, wherein the rotary valve is configured to be in the opened position to allow the volume of ambient air to enter the resonant chamber when a pressure at a front end of the resonant chamber is below atmospheric pressure.

20. The acoustic compression engine of claim 18, wherein the rotary valve is configured to be in the closed position to disallow the volume of ambient air to enter the resonant chamber when the pressure at a front end of the resonant chamber is above atmospheric pressure, wherein the pressure oscillations are generated within the resonant chamber subsequent to the rotary valve being configured to be in the closed position.
